(19) United States
(12) Patent Application Publication
(10) Pub. No.: US 2024/0168165 A1
(43) Pub. Date: May 23, 2024

(54) OPTICAL TRACKING DEVICE

(71) Applicant: PixArt Imaging Inc., Hsin-Chu City (TW)

(72) Inventors: Chung-Ting Yang, Hsin-Chu City (TW); Kai-Ho Tsai, Hsin-Chu City (TW)

(73) Assignee: PixArt Imaging Inc., Hsin-Chu City (TW)

(21) Appl. No.: 17/991,820

(22) Filed: Nov. 21, 2022

(51) Int. Cl. G01S 17/66

(52) U.S. Cl. CPC G01S 17/66

(57) ABSTRACT

An optical tracking device includes an optical detection module and a target component. The optical detection module includes an optical receiver. The target component includes a light penetrating body with at least one mark and movably disposed adjacent to the optical detection module. The target component allows an illumination beam penetrating into the light penetrating body, so that the optical detection module acquires a detection image containing a pattern of the mark for tracking a relative movement between the target component and the optical detection module.

### BACKGROUND OF THE INVENTION

### 1. Field of the Invention

The present invention relates to an optical tracking device, and more particularly, to an optical tracking device having a shortest working distance.

### 2. Description of the Prior Art

A conventional optical tracking device includes a moving component and a light detecting component. The moving component is located beside the light detecting component, and features points are set on a surface of the moving component close to the light detecting component. The moving component is made of opaque material. The illumination light output by the light detecting component does not penetrate the moving component, but is reflected back to the light detecting component after illuminating the feature points on the surface of the moving component. The light detecting component analyzes the reflected illumination light to obtain motion information of the feature points and the moving component. Generally, an interval between the moving component and the light detecting component of the conventional optical tracking device must be more than 0.5˜1.0 mm, which belongs to the work distance of the illumination light output by and the reflected illumination light received by the light detecting component. If the working distance is too low, the reflected illumination light cannot obtain clear information of the feature points. The optical tracking device is often used in a wearable electronic product; in order to meet a trend of thin and lighting in the consumer market, the working distance of the optical tracking device needs to be further shortened; the conventional optical tracking device obviously does not meet this requirement.

### SUMMARY OF THE INVENTION

The present invention provides an optical tracking device having a shortest working distance for solving above drawbacks.

According to the claimed invention, an optical tracking device includes an optical detection module and a target component. The optical detection module includes an optical receiver. The target component includes a light penetrating body with at least one mark and movably disposed adjacent to the optical detection module. The target component allows an illumination beam penetrating into the light penetrating body, so that the optical detection module acquires a detection image containing a pattern corresponding to the mark for tracking a relative movement between the target component and the optical detection module.

According to the claimed invention, the light penetrating body has a specific thickness used to provide a reflective path of a light spot formed by the mark whereon the illumination beam is projected, and the optical receiver faces the target component and captures the detection image containing the pattern corresponding to the light spot. Or, the light penetrating body has a specific thickness used to absorb the illumination beam for being a passive illumination body, and the optical receiver faces the target component and captures the detection image containing the pattern corresponding to a dark spot formed by the mark.

According to the claimed invention, the target component includes a first surface and a second surface opposite to each other, the first surface faces toward the optical detection module, and the mark is disposed on the second surface. The second surface is processed by non-mirror treatment, and texture on the second surface is used as the mark. The optical tracking device further includes a reflection component disposed on the second surface and used as the mark. The mark is further disposed on the first surface and the second surface, the illumination beam is absorbed by the light penetrating body and sheltered by the mark so as to provide the detection image containing the pattern corresponding to a dark spot.

According to the claimed invention, the target component includes two opposite ends and an outer annular surface located between the two opposite ends, the mark is disposed on the outer annular surface. The outer annular surface is processed by non-mirror treatment, and texture on the outer annular surface is used as the mark. The optical tracking device further includes a reflection component disposed on the outer annular surface and used as the mark. The illumination beam is absorbed by the light penetrating body and sheltered by the mark so as to provide the detection image containing the pattern corresponding to a dark spot.

According to the claimed invention, the target component comprises two opposite ends and an inner annular surface located between the two opposite ends, the mark is disposed on the inner annular surface.

According to the claimed invention, the optical detection module further includes an optical emitter corresponding to a surface of the target component facing the optical receiver. Or, the optical detection module further includes an optical emitter corresponding to a surface of the target component not facing the optical receiver.

The optical tracking device of the present invention can utilize the light penetrating material to manufacture the target component, and the target component can be attached to the optical detection module in a movable manner. The marks can be formed on the outer surface of the target component; the light penetrating body of the target component can utilize the specific thickness to be the reflective path. The illumination beam emitted by the optical emitter can pass through the light penetrating body to project onto the marks, and be reflected from the marks to the optical receiver through the light penetrating body; that is to say, the illumination beam can be transmitted back and forth within the light penetrating body, and the specific thickness of the light penetrating body can be interpreted as the reflective path. Therefore, the target component of the present invention can tightly contact the optical detection module or close to the optical detection module in the movable manner, and the optical tracking device can have the shortest working distance for meeting thin and light design requirements of the wearable electronic product.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an optical tracking device according to an embodiment of the present invention.

FIG. 2 is a diagram of the optical tracking device according to a first embodiment of the present invention.

FIG. 3 is a sectional view of the optical tracking device according to the first embodiment of the present invention.

FIG. 4 is a sectional view of the optical tracking device in another type according to the first embodiment of the present invention.

FIG. 5 is a diagram of the optical tracking device according to a second embodiment of the present invention.

FIG. 6 is a diagram of the optical tracking device according to a third embodiment of the present invention.

FIG. 7 is a diagram of the optical tracking device according to a fourth embodiment of the present invention.

FIG. 8 is a diagram of the optical tracking device according to a fifth embodiment of the present invention.

FIG. 9 is a sectional view of the optical tracking device according to the fifth embodiment of the present invention.

FIG. 10 is a sectional view of the optical tracking device according to another embodiment of the present invention.

### DETAILED DESCRIPTION

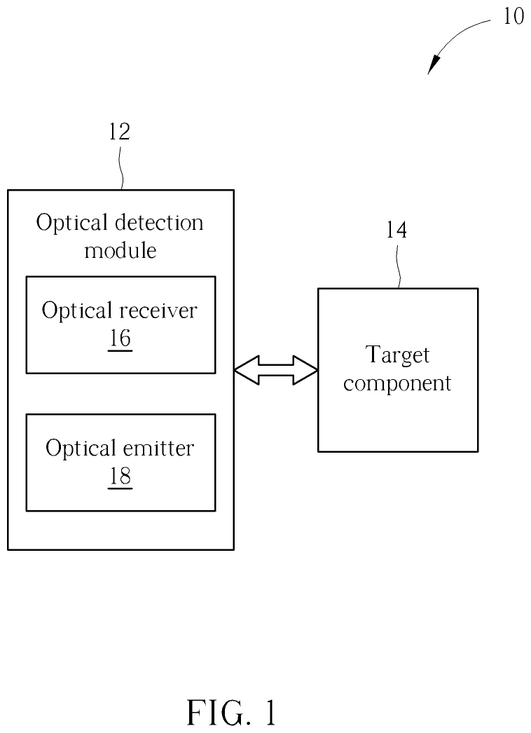

Please refer to FIG. 1. FIG. 1 is a functional block diagram of an optical tracking device 10 according to an embodiment of the present invention. The optical tracking device 10 can be applied to a wearable electronic product, such as the smart phone or a related apparatus. The optical tracking device 10 can include an optical detection module 12 and a target component 14. The target component 14 can be rotated and/or shifted in accordance with a behavior of the user. The optical detection module 12 can utilize a shortest working distance to detect a rotation angle and/or a shifting distance of the target component 14. The optical detection module 12 can at least include an optical receiver 16, and further include an optical emitter 18 optionally. The optical emitter 18 can emit an illumination beam to project onto the target component 14; the optical receiver 16 can acquire a detection image relevant to the target component 14 in accordance with the illumination beam reflected from the target component 14, and the detection image can be analyzed to acquire the rotation angle and/or the shifting distance of the target component 14.

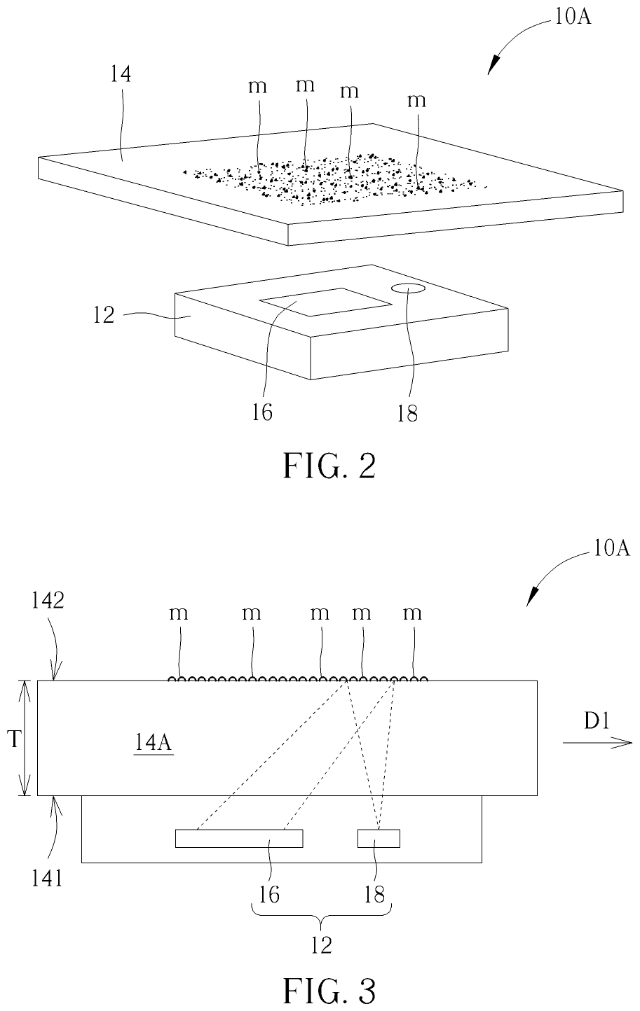

Please refer to FIG. 2 and FIG. 3. FIG. 2 is a diagram of the optical tracking device 10A according to a first embodiment of the present invention. FIG. 3 is a sectional view of the optical tracking device 10A according to the first embodiment of the present invention. The target component 14A can have a light penetrating body with one or several marks m, and be disposed adjacent to the optical detection module 12 in a movable manner. The target component 14A which is separated from the optical detection module 12 in FIG. 2 is used to clearly show relation between the optical receiver 16 and the optical emitter 18, and an actual arrangement of the target component 14A and the optical detection module 12 is not limited to the embodiment shown in the figures. A number of the marks m can depend on a design demand, and position and arrangement of the marks m are not limited to the embodiment shown in the figures. The light penetrating body can have a specific thickness T, and further have a first surface 141 and a second surface 142 opposite to each other. The first surface 141 can face the optical detection module 12. The marks m can be disposed on the second surface 142.

The illumination beam can pass through the first surface 141 and then enter the light penetrating body, and be projected onto the marks m on the second surface 142 for forming a pattern, such as a light spot. The optical receiver 16 can capture an image of the target component 14A to acquire the detection image containing the pattern corresponding to the marks m. The detection image can be analyzed to acquire the relative movement between the target component 14A and the optical detection module 12. Therefore, the specific thickness T of the target component 14A can be equal to a distance between the first surface 141 and the second surface 142, and can be interpreted as the reflective path of the illumination beam from the marks m to the optical receiver 16. The optical emitter 18 in the first embodiment may optionally be a laser light source. The light penetrating body of the target component 14A can be made of light penetrating material of allowing pass of the illumination beam from the laser light source.

It should be mentioned that the mark m may be a light sheltering component disposed on the second surface 142 via adhesive. Further, the optical tracking device 10A may optionally dispose at least one reflection component on the second surface 142 for being the marks m. The light sheltering component which is set as the marks m can form the dark spot on the detection image. The reflection component which is set as the marks m can form a highlight spot on the detection image. When the optical receiver 16 has common resolution, or due to light scattering effect, the detection image may not capture an accurate shape of the marks m, and the dark spot or the highlight spot may show a clear pattern or a blurred pattern within the detection image. The pattern corresponding to the marks m capable of extracting identifiable features to analyze and determine the rotation angle and/or the shifting distance of the target component 14 can conform to a design demand of the present invention. Moreover, the present invention may apply non-mirror treatment for the second surface 142, and texture of the second surface 142 which is rough structures due to the non-mirror treatment can be interpreted as the marks m.

When the target component 14A is moved relative to the optical detection module 12 in a first direction D1, the optical tracking device 10 can analyze a moving direction and a moving distance of the marks m within the detection image, so as to acquire motion information of the target component 14A. An operation processor used to analyze the detection image can be a built-in element of the optical receiver 16, or an independent unit separated from the optical receiver 16, or an external unit electrically connected to the optical tracking device 10 in a wire manner or in a wireless manner. Application of the operation processor can depend on the design demand.

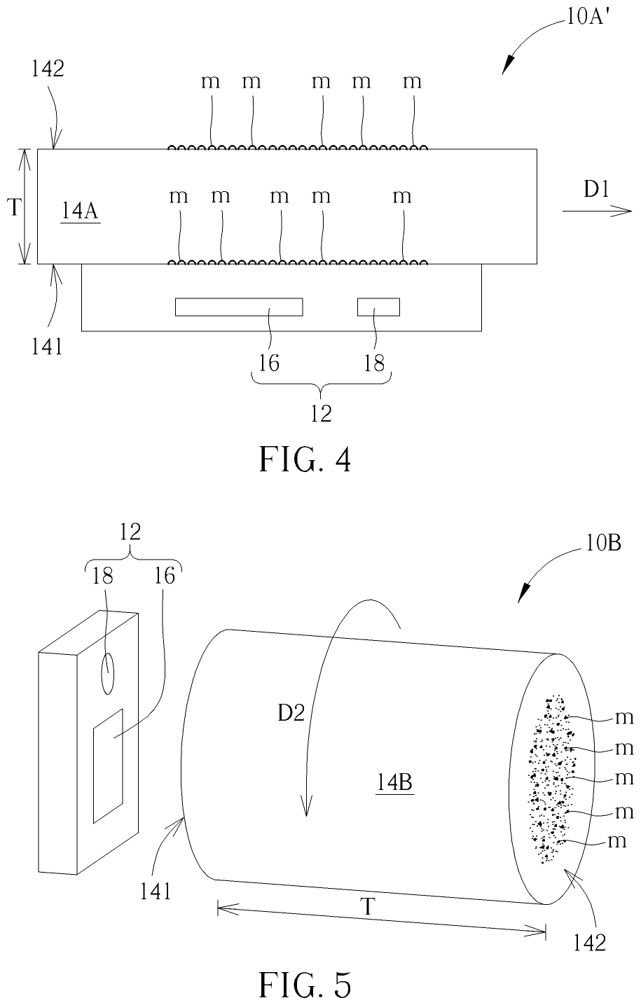

Please refer to FIG. 4. FIG. 4 is a sectional view of the optical tracking device 10A′ in another type according to the first embodiment of the present invention. In the foresaid type, the marks m can be disposed on the first surface 141 and the second surface 142 of the target component 14A, and the light penetrating body of the target component 14A can absorb the illumination beam. The target component 14A which absorbs the illumination beam can be used as a passive illumination body for illuminating the mark m. When the optical receiver 16 captures the image of the target component 14A, the detection image can contain the pattern corresponding to the dark spot formed by shelter of the marks m.

Please refer to FIG. 5. FIG. 5 is a diagram of the optical tracking device 10B according to a second embodiment of the present invention. In the second embodiment, elements having the same numerals as ones of the first embodiment have the same structures and functions, and a detailed description is omitted herein for simplicity. The target component 14B in the second embodiment can be a cylindrical structure. The marks m can be disposed on the second surface 142 of the target component 14B. When the target component 14B is rotated relative to the optical detection module 12 in a second direction D2, the optical tracking device 10 can analyze the rotation direction and the rotation angle of the marks m or the corresponding pattern within the detection image, so as to acquire rotation information of the target component 14B. The specific thickness T of the target component 14B (which means the cylindrical structure) can be interpreted as the reflective path of the illumination beam from the marks m to the optical receiver 16.

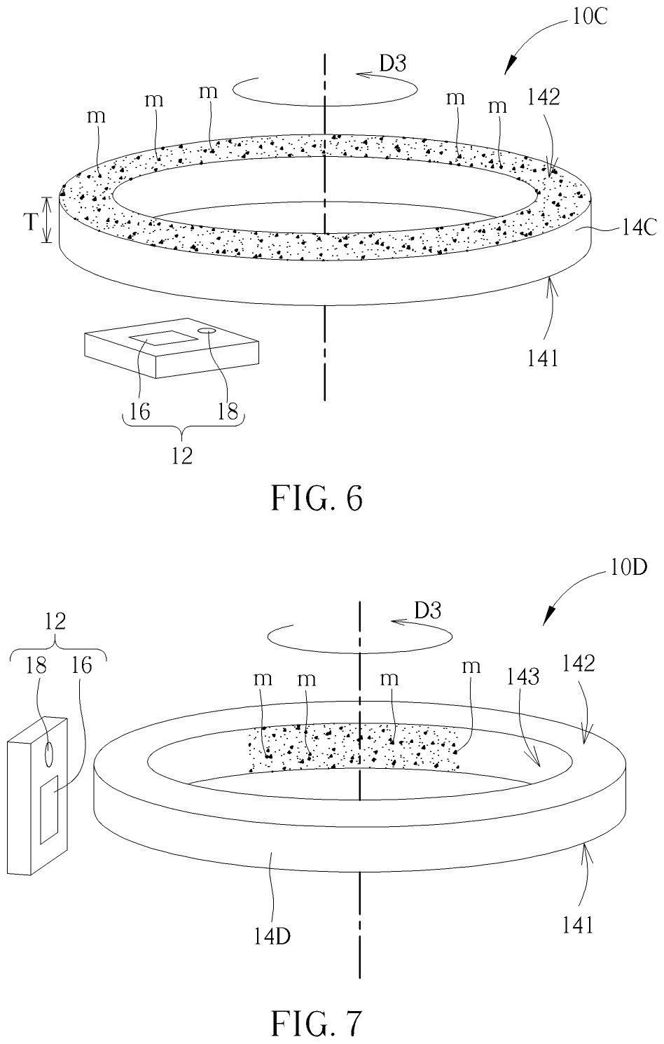

Please refer to FIG. 6. FIG. 6 is a diagram of the optical tracking device 10C according to a third embodiment of the present invention. In the third embodiment, elements having the same numerals as ones of the foresaid embodiments have the same structures and functions, and a detailed description is omitted herein for simplicity. The target component 14C in the third embodiment can be an annular structure, and the marks m can be disposed on the second surface 142 of the target component 14C. When the target component 14C is rotated relative to the optical detection module 12 in a third direction D3, the optical tracking device 10 can analyze the rotation direction and the rotation angle of the marks m or the corresponding pattern within the detection image to acquire rotation information of the target component 14C. The specific thickness T of the target component 14C (which means the annular structure) can be the reflective path of the illumination beam from the marks m to the optical receiver 16.

Please refer to FIG. 7. FIG. 7 is a diagram of the optical tracking device 10D according to a fourth embodiment of the present invention. In the fourth embodiment, elements having the same numerals as ones of the foresaid embodiments have the same structures and functions, and a detailed description is omitted herein for simplicity. The target component 14D in the fourth embodiment can be a disc structure; the disc structure can have two opposite surfaces 141 and 142, and an inner annular surface 143 located between the opposite surfaces 141 and 142. A space inside the inner annular surface 143 can be hollow or be filled. The marks m can be disposed on the inner annular surface 143 of the target component 14D. When the target component 14C is rotated relative to the optical detection module 12 in the third direction D3, the optical tracking device 10 can analyze the rotation direction and the rotation angle of the marks m or the corresponding pattern within the detection image, so as to acquire rotation information of the target component 14D. The specific thickness T of the target component 14D (which means the disc structure) in a lateral direction can be the reflective path of the illumination beam from the marks m to the optical receiver 16.

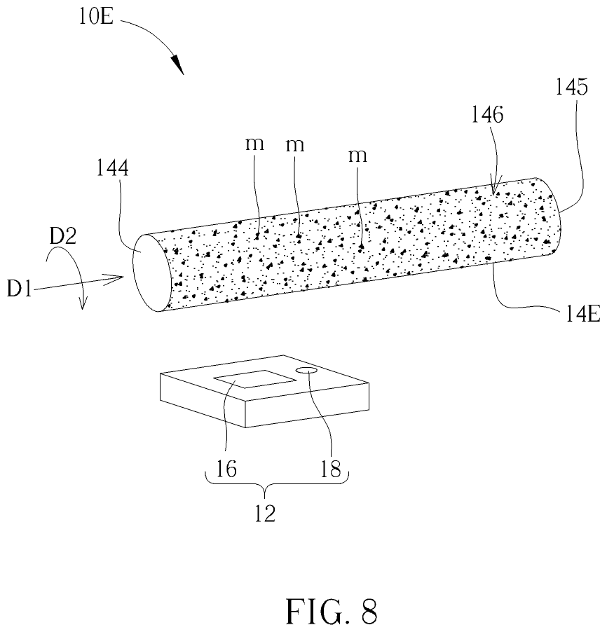

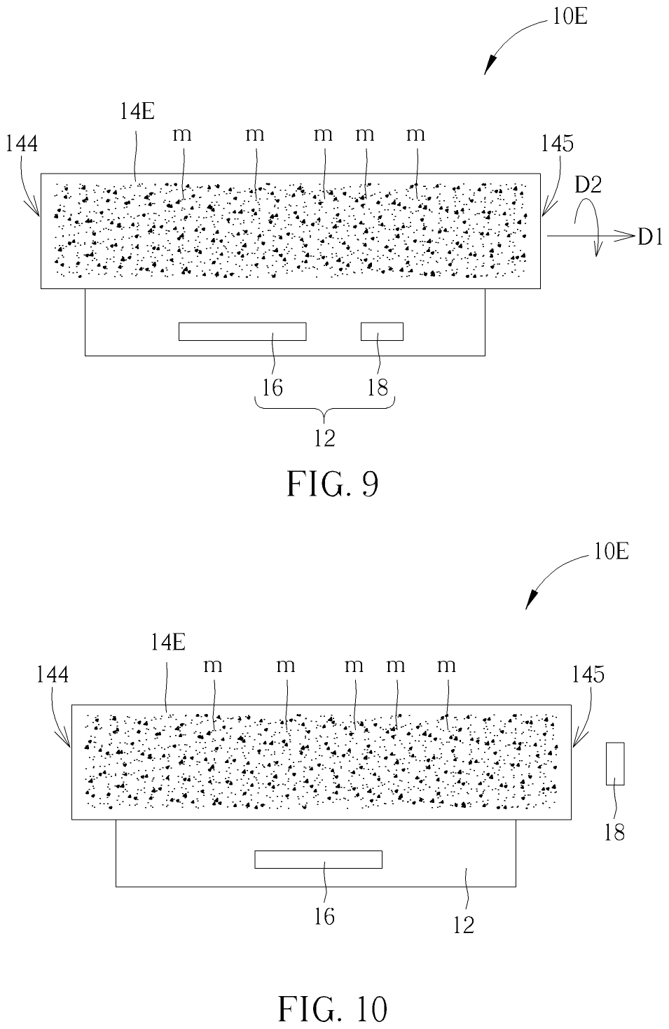

Please refer to FIG. 8 and FIG. 9. FIG. 8 is a diagram of the optical tracking device 10E according to a fifth embodiment of the present invention. FIG. 9 is a sectional view of the optical tracking device 10E according to the fifth embodiment of the present invention. In the fifth embodiment, elements having the same numerals as ones of the foresaid embodiments have the same structures and functions, and a detailed description is omitted herein for simplicity. The target component 14E in the fifth embodiment can utilize the light penetrating body to absorb the illumination beam for being the passive illumination body, and the light penetrating body can be the cylindrical structure. The target component 14E (which means the cylindrical structure) can have two opposite ends 144 and 145, and an outer annular surface 146 located between the two opposite ends 144 and 145. The marks m can be disposed on the outer annular surface 146. The marks m may be the light sheltering component disposed on the outer annular surface 146 via the adhesive; or, the optical tracking device 10E may optionally dispose the reflection component on the outer annular surface 146 for being the marks m. The light sheltering component which is used as the mark m can form the dark spot within the detection image. The reflection component which is used as the mark m can form the highlight spot within the detection image. Moreover, the present invention may apply the non-mirror treatment for the outer annular surface 146, and texture of the outer annular surface 146 can be used as the marks m.

When the target component 14E is moved relative to the optical detection module 12 in the first direction D1, or rotated relative to the optical detection module 12 in the second direction D2, the target component 14E which absorbs the illumination beam can be the passive illumination body. Due to the shelter of the marks m, the optical receiver 16 can capture the image of the target component 14A and acquire the detection image containing the pattern corresponding to the dark spots formed by the marks m. Besides, the present invention can preferably dispose the marks m on all or parts of the outer annular surface 146 of the target component 14E, which depends on the actual demand. For example, the marks m may be formed inside the target component 14E, which means the marks m can be embedded inside the light penetrating body of the target component 14E. The optical emitter 18 of the optical tracking device 10E can optionally be a light emitting diode. The light penetrating body of the target component 14E can be made of light penetrating material of allowing pass of the illumination beam from the light emitting diode.

As shown in FIG. 9, the optical emitter 18 can be disposed by the optical receiver 16, such as being disposed on position corresponding to a surface of the target component 14E facing the optical receiver 16; the optical receiver 16 and the optical emitter 18 can be both located in the same package structure of the optical detection module 12. In other possible embodiment, the optical emitter 18 may be disposed on another position corresponding to a surface of the target component 14E not facing the optical receiver 16. Please refer to FIG. 10. FIG. 10 is a sectional view of the optical tracking device 10E according to another embodiment of the present invention. As shown in FIG. 10, the optical emitter 18 can be optionally disposed on a lateral side of the target component 14E; meanwhile, the optical emitter 18 may be an auxiliary element of the optical detection module 12 but be separable from the optical receiver 16, or the optical emitter 18 can be an external element so that the optical tracking device 10 does not have an illumination function and the target component 14E is illuminated by ambient light.

In conclusion, the optical tracking device of the present invention can utilize the light penetrating material to manufacture the target component, and the target component can be attached to the optical detection module in a movable manner. The marks can be formed on the outer surface of the target component; the light penetrating body of the target component can utilize the specific thickness to be the reflective path. The illumination beam emitted by the optical emitter can pass through the light penetrating body to project onto the marks, and be reflected from the marks to the optical receiver through the light penetrating body; that is to say, the illumination beam can be transmitted back and forth within the light penetrating body, and the specific thickness of the light penetrating body can be interpreted as the reflective path. Therefore, the target component of the present invention can tightly contact the optical detection module or close to the optical detection module in the movable manner, and the optical tracking device can have the shortest working distance for meeting thin and light design requirements of the wearable electronic product.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical tracking device, comprising:
an optical detection module comprising an optical receiver; and
a target component comprising a light penetrating body with at least one mark and movably disposed adjacent to the optical detection module, the target component allowing an illumination beam penetrating into the light penetrating body, so that the optical detection module acquires a detection image containing a pattern corresponding to the mark for tracking a relative movement between the target component and the optical detection module.

2. The optical tracking device of claim 1, wherein the light penetrating body has a specific thickness used to provide a reflective path of a light spot formed by the mark whereon the illumination beam is projected, and the optical receiver faces the target component and captures the detection image containing the pattern corresponding to the light spot.

3. The optical tracking device of claim 1, wherein the light penetrating body has a specific thickness used to absorb the illumination beam for being a passive illumination body, and the optical receiver faces the target component and captures the detection image containing the pattern corresponding to a dark spot formed by the mark.

4. The optical tracking device of claim 1, wherein the target component comprises a first surface and a second surface opposite to each other, the first surface faces toward the optical detection module, and the mark is disposed on the second surface.

5. The optical tracking device of claim 4, wherein the second surface is processed by non-mirror treatment, and texture on the second surface is used as the mark.

6. The optical tracking device of claim 4, wherein the optical tracking device further comprises a reflection component disposed on the second surface and used as the mark.

7. The optical tracking device of claim 4, wherein the mark is further disposed on the first surface and the second surface, the illumination beam is absorbed by the light penetrating body and sheltered by the mark so as to provide the detection image containing the pattern corresponding to a dark spot.

8. The optical tracking device of claim 1, wherein the target component comprises two opposite ends and an outer annular surface located between the two opposite ends, the mark is disposed on the outer annular surface.

9. The optical tracking device of claim 8, wherein the outer annular surface is processed by non-mirror treatment, and texture on the outer annular surface is used as the mark.

10. The optical tracking device of claim 8, wherein the optical tracking device further comprises a reflection component disposed on the outer annular surface and used as the mark.

11. The optical tracking device of claim 8, wherein the illumination beam is absorbed by the light penetrating body and sheltered by the mark so as to provide the detection image containing the pattern corresponding to a dark spot.

12. The optical tracking device of claim 1, wherein the target component comprises two opposite ends and an inner annular surface located between the two opposite ends, the mark is disposed on the inner annular surface.

13. The optical tracking device of claim 1, wherein the optical detection module further comprises an optical emitter corresponding to a surface of the target component facing the optical receiver.

14. The optical tracking device of claim 1, wherein the optical detection module further comprises an optical emitter corresponding to a surface of the target component not facing the optical receiver.
